(19) United States
(12) Patent Application Publication
(10) Pub. No.: US 2006/0072083 A1
(43) Pub. Date: Apr. 6, 2006

(54) Projector

(75) Inventor: Hiroyuki Meguro, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/243,426

(22) Filed: Oct. 5, 2005

(30) Foreign Application Priority Data
Oct. 6, 2004 (JP) 2004-293784

(51) Int. Cl. G03B 21/22

(52) U.S. Cl. 353/119

(57) ABSTRACT

A projector includes a light source, an electro-optic device, a projection device, and a first seat and a second seat. The electro-optic device has plural light modulation devices that modulate lights emitted from the light source according to image information, and a light combining device, provided with plural light incident-side end faces to which the plural light modulation devices are attached, that combines respective lights modulated in the plural light modulation devices to form an optical image. The projection device includes at least one lens and a lens barrel accommodating and holding the lens, and projects the optical image formed in the electro-optic device in an enlarged form. The lens barrel includes a flange portion that expands outward in a base end portion in a projection direction. The first seat and the second seat are formed as separate bodies and are attached, respectively, to opposing two end faces of the light combining device that are orthogonal to the plural light incident-side end faces. The electro-optic device and the projection device are combined into one unit, the first seat and the second seat being connected to the flange portion.

This application claims the benefit of Japanese Patent Application No. 2004-293784, filed Oct. 6, 2004. The entire disclosure of the prior application is hereby incorporated by reference herein in its entirety.

### BACKGROUND

The exemplary embodiments relate to a projector.

In the related art three-plate type projector, by which a light emitted from a light source lamp is separated into lights of three colors, includes R, Q and B, in a color separation system. The color separation system may include a dichroic mirror. The separated lights are modulated color by color according to image information in three light modulation devices. An optical image is formed by combining the lights modulated in the respective light modulation devices using a cross dichroic prism employed as a light combining system, and the optical image is projected in an enlarged form from a projection system, such as a projection lens.

In order to simplify the structure and the assembly process of such a three-plate type projector, as disclosed, for example, in JP-A-2001-42425, a projector includes three light modulation devices, the cross dichroic prism, and the projection lens combined into one unit.

The projector in the cited JP-A-2001-42425 uses a prism holder and a lens holder to combine the three light modulation devices, the cross dichroic prism, and the projection lens into one unit.

The prism holder includes a base, and a pair of attachment portions protruding perpendicularly from the base, which are formed as one piece. The top and bottom surfaces of the cross dichroic prism are bonded and fixed to the pair of attachment portions. Also, the upper edge and both edges on the right and left of the base are formed to protrude toward a light exiting side.

Meanwhile, the lens holder includes a plate body of an almost rectangular shape when viewed in a plane, and guiding grooves are formed in the light exiting-side end face from the upper edge toward the lower end.

When the prism holder and the lens holder are combined into one unit, respective pillars of the base forming the prism holder that protrude toward the light exiting side from both edges on the right and left are inserted into the guiding grooves. When the respective pillars are inserted into the guiding grooves, a portion of the base forming the prism holder that protrudes from the upper edge toward the light exiting side abuts on the upper end face of the lens holder, while the protrusions formed at the lower end portions of the respective pillars abut on the bottom portions of the guiding grooves in the lens holder. The portion of the base protruding from the upper edge toward the light exiting side is fixed to the upper end face of the lens holder, and the respective protrusions are fixed to the bottom portions of the guiding grooves with screws.

In the projector of the cited JP-A-2001-42425, a pair of attachment portions is formed integrally with the base. It is thus necessary to form the pair of attachment portions at a high degree of accuracy in response to a dimensional tolerance of the cross dichroic prism for the top and bottom surfaces of the cross dichroic prism to be bonded and fixed to the pair of attachment portions. Moreover, it is necessary to prepare various kinds of prism holders, each having a pair of attachment portions at a different position, for various kinds of cross dichroic prism of dimensions that vary from type to type of the projector.

Under these circumstances, the cost of manufacturing of the prism holder is rising, which in turn raises the cost of manufacturing of the projector.

### SUMMARY

An exemplary embodiment may be advantageous in that it is possible to provide a projector in which an electro-optic device and a projection device are combined into one unit while reducing the cost of manufacturing.

A projector according to an aspect of the exemplary embodiments includes: a light source; an electro-optic device having plural light modulation devices that modulate lights emitted from the light source according to image information, and a light combining device, provided with plural light incident-side end faces to which the plural light modulation devices are attached, that combines respective lights modulated in the plural light modulation devices to form an optical image; a projection device that includes at least one lens and a lens barrel accommodating and holding the lens, and projects the optical image formed in the electro-optic device in an enlarged form; and a first seat and a second seat formed as separate bodies and attached, respectively, to opposing two end faces of the light combining device that are orthogonal to the plural light incident-side end faces. The lens barrel including a flange portion that expands outward in a base end portion in a projection direction. Also, the electro-optic device and the projection device are combined into one unit as the first seat and the second seat are connected to the flange portion.

According to one aspect of the exemplary embodiments, because the first seat and the second seat are formed as separated bodies, the electro-optic device and the projection device can be combined into one unit, for example, in the below described manner.

That is, after the posture and the state of the light combining device is adjusted, for example, the second seat is fixed to one of the end faces of the light combining device that intersect with the plural light incident-side end faces. Subsequently, the second seat is connected to the flange portion of the projection device. Finally, the first seat is fixed to the other one of the end faces of the light combining device that intersect with the plural light incident-side end faces, and is then connected to the flange portion of the projection device.

As has been described, by forming the first seat and the second seat as separate bodies, it is possible to achieve the configuration in which the relative positions of the first seat and the second seat can be changed as needed. Hence, not so high accuracy is needed for the first seat and the second seat in comparison with the configuration in the related art in which a pair of attachment portions need to be formed at a high degree of accuracy in response to a dimensional tolerance of the light combining device. In addition, because the configuration is compatible to various kinds of light combining devices having dimensions that vary from type to type of the projector. This, unlike the related art, eliminates the need to manufacture various kinds of prism holder for various kinds of light combining devices having different dimensions. The cost of manufacturing of the first seat and the second seat can thereby be reduced, which in turn can reduce the cost of manufacturing the projector.

Also, because the light combining device is fixedly pinched by the first seat and the second seat, a force applied to the electro-optic device from the outside can be suppressed by way of the first seat, the second seat, and the flange portion. It is thus possible to suppress or discourage mutual misalignment of the plural light modulation devices attached to the plural light incident-side end faces of the light combining device. A satisfactory optical image having no pixel displacements can therefore be projected in an enlarged form.

In an exemplary embodiment, the first seat and the second seat include first supporting surfaces extending along the two end faces of the light combining device and attached, respectively, to the two end faces, and second supporting surfaces both extending to be almost orthogonal to the first supporting surfaces and connected to a light incident-side end face of the flange portion.

Incidentally, in the projector disclosed in JP-A-2001-42425 supra, the three light modulation devices, the cross dichroic prism, and the projection lens are positioned by forming guiding groves in the lens holder and by inserting the respective pillars of the prism holder into the guiding grooves. It is thus necessary to form not only the prism holder but also the lens holder at a high degree of accuracy.

According to one aspect of the exemplary embodiments, however, each of the first seat and the second seat has the first supporting surface and the second supporting surface almost orthogonal to each other, and both second supporting surfaces are connected to the light of the incident-side end face of the flange portion. That is, the connection directions of the first seat and the second seat to the flange portion are set in the optical axis direction of lights coming out from the light combining device and heading toward the projection device. Hence, different from the configuration in the related art in which the guiding grooves are formed in the lens holder at a high degree of accuracy, it is possible to position the first seat, the second seat, and the flange portion at a high degree of accuracy. That is, it is possible to position the electro-optic device and the projection device at a high degree of accuracy, by forming, with satisfactory accuracy, at least the second supporting surfaces of the first seat and the second seat and the light incident-side end face of the flange portion. Hence, not only can the cost of manufacturing of the first seat and the second seat be reduced, but also the cost of manufacturing of the flange portion can be reduced, which can in turn further reduce the cost of manufacturing of the projector.

In addition, for example, when the first seat, the second seat, and the flange portion are manufactured through mold processing, it is easy to mold the respective connection surfaces of the respective second supporting surfaces and the light incident-side end face of the flange portion at a high degree of accuracy, in comparison with the case in the related art where the respective connection surfaces, which are connected in the top-to-bottom direction that is orthogonal to the optical axis direction, are formed with satisfactory accuracy. The cost of manufacturing of the first seat, the second seat, and the flange portion can thus be reduced further, which can in turn further reduce the cost of manufacturing the projector.

In an exemplary embodiment, the projector further includes a screen, at least one of the first seat and the second seat being fixed to the light incident-side end face of the flange portion with the screw. Any one of, at least one of the first seat and the second seat, and the flange portion being provided with a track hole, through which the screw is inserted and with which a relative position of the seat and the flange portion is changed while the screw is inserted.

According to one aspect of the exemplary embodiments, because at least one of the first seat and the second seat, and the flange portion is provided with a track hole, the seat is allowed to move with respect to the flange portion while the seat is attached to the flange portion with a screw. The seat is thus moved while the seat is attached to the flange portion with the screw until the seat abuts on the light combining device, so that they are fixed to each other, after which the seat and the flange portion are fixed by tightening the screw. It is thus possible to perform the work to combine the electro-optic device and the projection lens into one unit promptly with ease using a simple configuration.

In an exemplary embodiment, at least one of the first seat and the second seat is provided with a bulged portion that bulges out in an out-plane direction on a supporting surface that abuts the light combining device.

According to one aspect of the exemplary embodiments, because at least one of the first seat and the second seat is provided with the bulged portion on the supporting surface, for example, when the seat and the light combining device are bonded and fixed to each other using a bonding agent, a clearance defined by the shape of the curved surface of the bulged portion and the end face of the light combining device can be filled with the bonding agent. Hence, for example, when the light combining device abuts the supporting surface while the bonding agent is applied to the supporting surface, the bonding agent flows in a direction toward the clearance, which enables the light combining device to be fixed in a reliable manner. The projector can be therefore manufactured in a satisfactory manner.

In an exemplary embodiment, at least one of the first seat and the second seat is bonded and fixed to at least one of the two end faces of the light combining device with a bonding agent, and includes a concave portion, formed as a bonding agent reservoir, in a supporting surface that abuts on the light combining device.

According to the exemplary embodiments, because at least one of the first seat and the second seat is provided with the concave portion formed as the bonding agent reservoir in the supporting surface, the concave portion can be filled with the bonding agent when the seat and the light combining device are bonded and fixed to each other using a bonding agent. Hence, for example, when the light combining device abuts on the supporting surface while the bonding agent is applied to the supporting surface, the bonding agent flows in a direction toward the concave portion. This prevents the bonding agent from flowing out on the plural light incident-side end faces of the light combining device. It is thus possible to prevent the bonding agent from adhering to unwanted portions. The projector can therefore be manufactured in a satisfactory manner.

In an exemplary embodiment, one of the first seat and the second seat is provided with a connection portion that extends along the light incident-side end face of the flange portion and is connected to the light incident-side end face, and the other one of the first seat and the second seat is connected to the light incident-side end face of the flange portion via the connection portion.

According to one aspect of the exemplary embodiments, because one of the first seat and the second seat has a connection portion, it is possible to enlarge a connected area between the seat and the flange portion and to secure more connected points. One of the seats is thus able to maintain the supporting state of the electro-optic device with respect to the projection device in a satisfactory manner. Also, the seat, together with the other seat, is able to further suppress a force applied to the electro-optic device from the outside. Mutual misalignment of the plural light modulation devices attached to the plural light incident-side end faces of the light combining device can be therefore suppressed further. It is thus possible to project a sharp optical image having no pixel displacements in an enlarged form.

In an exemplary embodiment, one of the first seat and the second seat is formed integrally with the flange portion.

According to one aspect of the exemplary embodiments, because one of the first seat and the second seat is formed integrally with the flange portion, one of the seats is able to maintain the supporting state of the electro-optic device with respect to the projection device in a satisfactory manner. Also, the seat, together with the other seat, is able to further suppress a force applied to the electro-optic device from the outside. It is thus possible to project a sharp optical image having no pixel displacements in an enlarged form.

In addition, by forming one of the seats integrally with the flange portion, the number of components used to combine the projection device and the electro-optic device into one unit can be lessened. Hence, the assembly work to combine the projection device and the electro-optic device into one unit can be readily performed, which can in turn reduce the cost of manufacturing of the projector.

In an exemplary embodiment, the first seat and the second seat have an identical shape.

According to one aspect of the exemplary embodiments, because the first seat and the second seat are the identical shape, the first seat and the second seat can be manufactured using the same manufacturing device through the same manufacturing method by using the first seat and the second seat in common. The cost of manufacturing of the first seat and the second seat can therefore be reduced, which can in turn further reduce the cost of manufacturing the projector.

In an exemplary embodiment, the projector further includes a box-shaped armor housing that accommodates the light source, the electro-optic device, and the projection device, and a transmissive screen, provided to be exposed to any of box-shaped side surfaces of the armor housing, on which the optical image projected from the projection device in an enlarged form is projected.

The projector according to one aspect of the exemplary embodiments is a rear projector that includes the armor housing and the transmissive screen and thereby projects an optical image in a direction opposite to a direction in which the user views the transmissive screen. The rear projector may adopt the configuration in which the output values of the built-in speakers are high in comparison with a front projector that projects an optical image from a direction in which the user views the screen. However, by adopting the structure in which the electro-optic device and the projection device are combined into one unit as described above to the rear projector, transmission of an external force (in particular vibrations caused by outputs from the speakers) to the electro-optic device can be effectively suppressed or discovered. It is thus possible to project a sharp optical image having no pixel displacements onto the transmissive screen.

### BRIEF DESCRIPTION OF THE DRAWINGS

The invention will be described with reference to the accompanying drawings, wherein like numbers reference like elements, and wherein:

FIG. 1 is a sectional side elevation of a rear projector according to a first exemplary embodiment;

FIG. 2 is a plan view schematically showing an optical unit incorporated into the rear projector in the first exemplary embodiment;

FIG. 3 is a view showing the configuration of an optical device main body in the first exemplary embodiment;

FIG. 4 is another view showing the configuration of the optical device main body in the first exemplary embodiment;

FIG. 5 is a view showing the optical device main body in the first exemplary embodiment when viewed in the +Z-axis direction in FIG. 3 and FIG. 4;

FIG. 6 is an exploded perspective view showing the structure of an optical device main body according to a second exemplary embodiment; and

FIG. 7 is an exploded perspective view showing the structure of an optical device main body according to a third exemplary embodiment.

### DETAILED DESCRIPTION OF EMBODIMENTS

<First Exemplary Embodiment>

Hereinafter, a first exemplary embodiment will be described with reference to the drawings.

(Chief Configuration of Rear Projector)

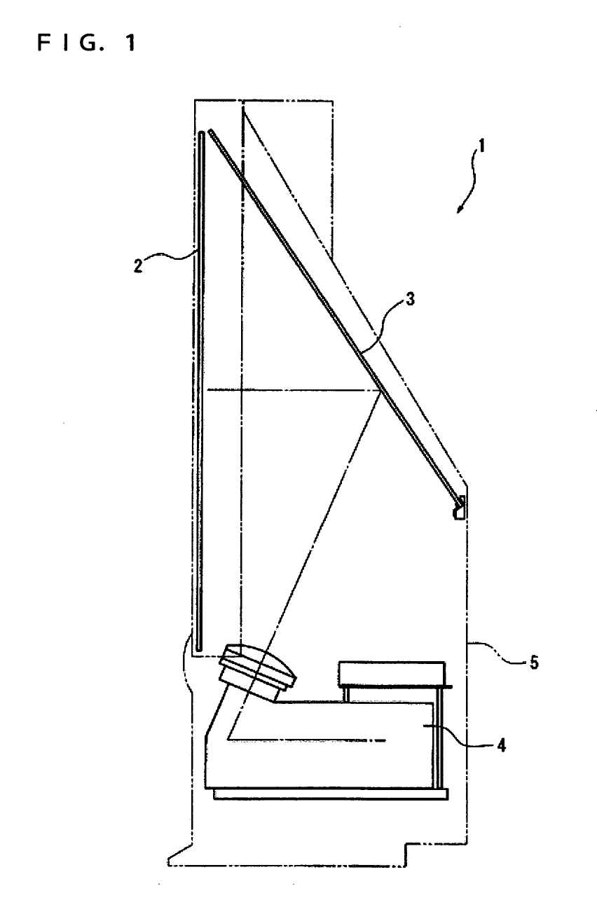

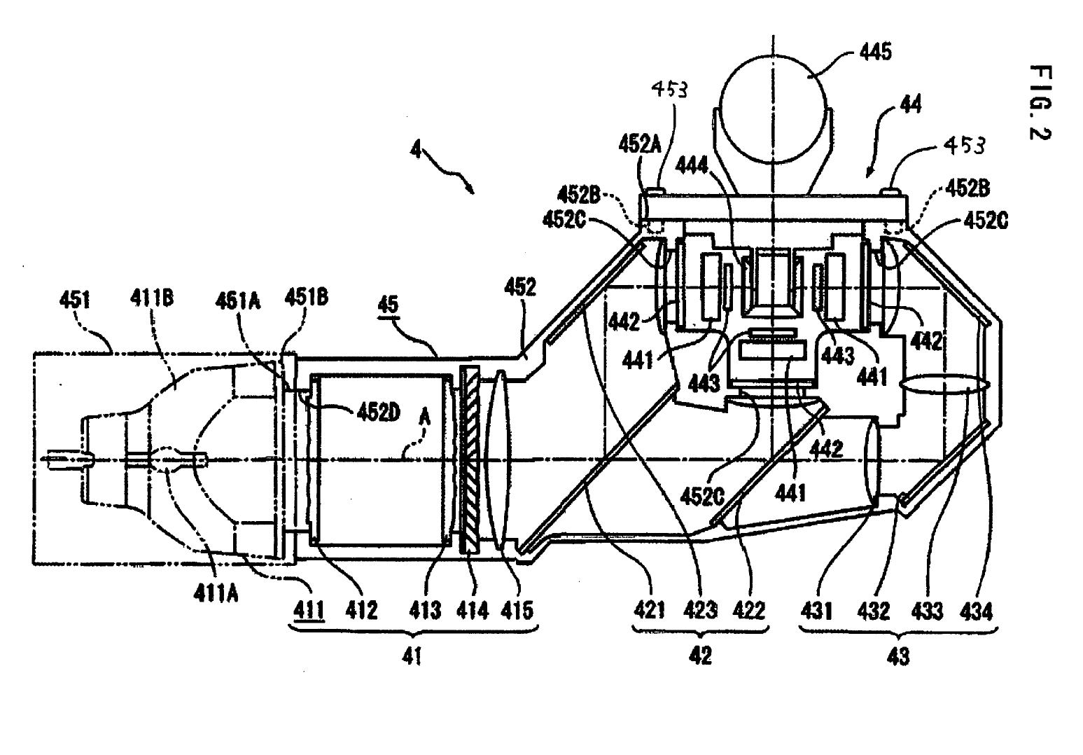

FIG. 1 is a sectional side elevation of a rear projector according to the first exemplary embodiment. FIG. 2 is a plan view schematically showing an optical unit incorporated into the rear projector.

Referring to FIG. 1, numeral 1 denotes a rear projector, and broadly speaking, the rear projector 1 includes: an optical unit 4 that forms and projects an optical image; a reflection mirror 3 on which the optical image projected from the optical unit 4 is reflected; a transmissive screen 2 onto which the optical image is projected via the reflection mirror 3; and an armor housing 5 inside of which are disposed the optical unit 4, the reflection mirror 3, and the transmissive screen 2. Although it is not shown concretely in the drawing, components other than the optical unit 4, the reflection mirror 3, and transmissive screen 2 are also disposed inside the armor housing 5, such as a power supply unit that supplies the optical unit 4 and other components with power from the outside, a cooling unit including a cooling fan that takes the heat from the interior of the rear projector 1, speakers that output sounds on the basis of sound information supplied from the outside, and a control unit that controls the optical unit 4 and the speakers, respectively, to form an optical image and output sounds on the basis of image information, sound information, etc., supplied from the outside.

As is shown in FIG. 2, the optical unit 4 includes an optical illumination integration system 41, a color separation system 42, a relay system 43, an optical device 44, and a housing 45 for optical components.

As is shown in FIG. 2, the optical illumination integration system 41 includes a light source 411 having a light source lamp 411A and a reflector 411B, a first lens array 412, a second lens array 413, a polarization conversion element 414, and a superimposing lens 415.

Lights emitted from the light source lamp 411A are aligned in the same exiting direction in the reflector 411B. Respective lights are then divided into plural partial lights in the first lens array 412 and form images in close proximity to the second lens array 413. Respective partial lights coming out from the second lens array 413 are converted into substantially one kind of polarized lights in the polarization conversion element 414, and go incident on the superimposing lens 415. Further, plural partial lights coming out from the superimposing lens 415 are superimposed on the light modulation devices (liquid crystal panels) that together form the optical device 44 and will be described below.

As is shown in FIG. 2, the color separation system 42 includes two dichroic mirrors 421 and 422, and a reflection mirror 423. The dichroic mirrors 421 and 422 provide the function of separating plural partial lights coming out from the optical illumination integration system 41 into color lights of three colors including red (R), green (G), and blue (B).

As is shown in FIG. 2, the relay system 43 includes a light incident-side lens 431, a relay lens 433, and reflection mirrors 432 and 434. The relay system 43 is furnished with the function of guiding color lights separated in the color separation system 42 to the optical modulation devices that together form the optical device 44 and will be described below.

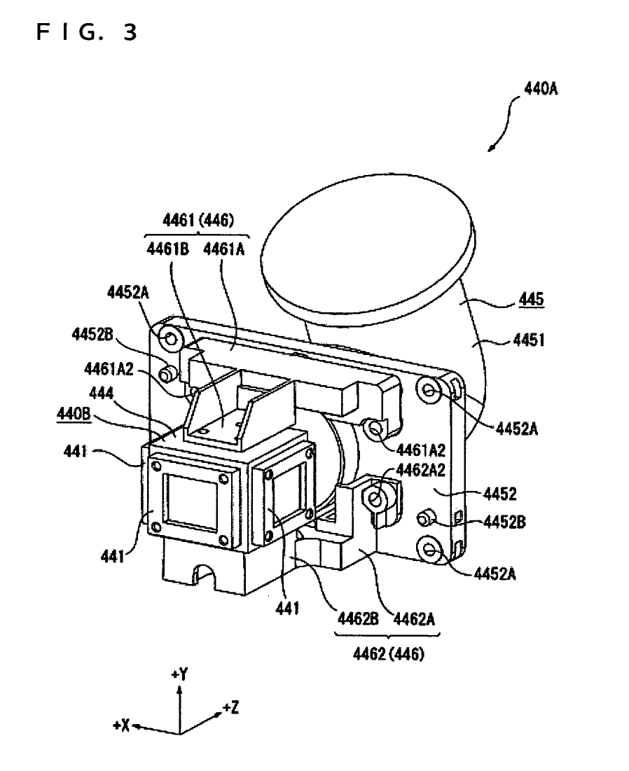

The optical device 44 modulates three color lights coming out from the color separation system 42 individually according to image information, and combines the respective modulated color lights to form a color image that is projected in an enlarged form. As is shown in FIG. 2, the optical device 44 includes three light modulation devices 441 each having a liquid crystal panel 4411 (see FIG. 3), a light incident-side polarizer 442 and a light exiting-side polarizer 443 disposed, respectively, on the light incident side and the light exiting side of each light modulation device 441, a cross dichroic prism 444 used as a light combining device, and a projection lens 445 used as a projection device. Of these components, the three light modulation devices 441, the three light exiting-side polarizers 443, the cross dichroic prism 444, and the projection lens 445 are combined into one unit, and thereby constitute an optical device main body 440A (see FIG. 3). The configuration of the optical device main body 440A will be described in detail below. Alternatively, the optical device main body 440A may be constituted by combining the three light modulation devices 441, the three light exiting-side polarizers 443, the cross dichroic prism 444, and the three light incident-side polarizers 442 into one unit.

Respective color lights, having been aligned in almost one polarization direction in the polarization conversion element 414, go incident on the corresponding light incident-side polarizers 442. Of these incident lights, each light incident-side polarizer 442 transmits only the polarized lights in substantially the same direction as the polarization axis of the lights aligned in the polarization conversion element 414, and absorbs the other lights. The light incident-side polarizer 442 is formed, for example, by laminating a polarization filter on a light-transmissive substrate made of sapphire glass, berg crystal, etc.

Although it is not shown concretely in the drawing, the liquid crystal panel 4411 forming the light modulation device 441 is formed by sealing hermetically a liquid crystal, which is an electro-optic medium, in a space between a pair of transparent glass substrates. The orientation of the liquid crystal is controlled according to a driving signal outputted from an unillustrated control substrate in modulating a polarization direction of polarized lights coming out from the light incident-side polarizer 442.

The light exiting-side polarizers 443 are of substantially the same configuration as the light incident-side polarizers 442. Hence, of the lights coming out from the corresponding light modulation device 441, each light exiting-side polarizer 443 transmits only the lights having the polarization axis orthogonal to the transmission axis of lights passing through the light incident-side surface 442, and absorbs the other lights.

The cross dichroic prism 444 is an optical element that combines optical images modulated for each color and coming out from the light exiting-side plates 443 to form a color image. The cross dichroic prism 444 includes four rectangular prisms laminated in a rectangular shape when viewed in a plane, and two dielectric multi-layer filters formed on the interfaces where rectangular prisms are laminated to each other. These dielectric multi-layer filters transmit color lights coming out from the light modulation device 441 disposed on the opposing side to the projection lens 445 via the light exiting-side polarizer 443, and reflect color lights coming out from the other two light modulation devices 441 and 441 via the light exiting-side polarizers 443. Respective color lights modulated in the corresponding light modulation devices 441 are then combined to form a color image.

The projection lens 445 is disposed on the light exiting side of the cross dichroic prism 444, enlarges a color image coming out from the cross dichroic prism 444, and projects the color image toward the reflection mirror 3 by bending the color image projected forward to travel toward the upper side. The projection lens 445 having, for example, an adequate projected angle is chosen for each type of the rear projector 1. The structure of the projection lens 445 will be described in more detail below, when the configuration of the optical device main body 440A is described.

As is shown in FIG. 2, a predetermined illumination optical axis A is set in the housing 45 for optical components, and the optical elements 41 through 43, and the optical device 44 are disposed at specific positions with respect to the illumination optical axis A. As is shown in FIG. 2, the housing 45 for optical components includes a light source accommodating member 451, a component accommodating member 452, and unillustrated lid-shaped member. The light source accommodating member 451 and the component accommodating member 452 are not necessarily separated bodies, and they may be formed as one piece.

As is shown in FIG. 2, the light source accommodating member 451 is a housing that accommodates the light source 411, and is formed to be connectable to the component accommodating member 452.

As is shown in FIG. 2, in a connected portion to the component accommodating member 452, the light source accommodating member 451 is provided with an opening 451A for lights emitted from the light source 411 to pass through. Explosion-proof glass 451B is attached so as to clog the opening 451A.

Although it is not shown concretely in the drawing, the light source accommodating member 451 is provided with a slit-shaped opening in the opposing end face, so that air will flow in and out to circulate through the light source accommodating member 451. The light source 411 disposed inside is thus cooled by air that flows in and out through the opening.

As is shown in FIG. 2, the component accommodating member 452 is open on the upper side. It is connected to the light source accommodating member 451 at one end, and at the other end, it is shaped like a container almost in the shape of a capital U when viewed in a plane. Not only the optical components 412 through 415, 421 through 423, 431 through 434, and 442 are accommodated inside, but also the optical device main body 440A described below is disposed inside the portion at the other end in the shape of a capital U when viewed in a plane.

In the component accommodating member 452, as is shown in FIG. 2, the outer peripheral surface of the tip ends of the U-shaped portion at the other end functions as a supporting surface 452A that supports the optical device main body 440A. The supporting surface 452A is provided with four screw holes 452B (only two screw holes 452B are shown in FIG. 2) used to fix the optical device main body 440A, and two positioning holes (not shown). By supporting the optical device main body 440A on the supporting surface 452A of the component accommodating member 452, as is shown in FIG. 2, the three light modulation devices 441, the three light exiting-side polarizers 443, and the cross dichroic prism 444 are disposed inside the U-shaped portion at the other end.

The end faces on the inside of the U-shaped portion at the other end of the component accommodating member 452 are provided with openings 452C for allowing lights to pass through, to correspond to the light incident-side end faces of the cross dichroic prism 444 disposed inside the U-shaped portion, and the light incident-side polarizers 442 are attached to clog the opening portions 452C.

Further, the component accommodating member 452 is provided with an opening 452D at one end for allowing lights emitted from the light source 411 to pass through, and the first lens array 412 is attached to clog the opening 452D.

Furthermore, the inner surface of the side surface of the component accommodating member 452 is provided with grooves, protrusions, etc., and the optical components 413 through 415, 421 through 423, and 431 through 434 are attached using these grooves and protrusions.

The lid-shaped member is a member that clogs the opening of the component accommodating member 452 on the upper side, and is of a shape corresponding to the planar shape of the component accommodating member 452.

The reflection mirror 3 is disposed on the back surface side of the armor housing 5 of the rear projector 1, and is a typical reflection mirror formed in almost a trapezoidal shape. As is shown in FIG. 1, the reflection mirror 3 reflects a color image projected from the optical unit 4 to the back surface side of the transmissive screen 2.

The transmissive screen 2 is a typical, rectangular transmissive screen, and includes, for example, a diffusing plate, a Fresnel sheet, a lenticular sheet, a protective plate, etc., in this order, from the back surface side. A color image, which has been enlarged in the optical unit 4 and reflected on the reflection mirror 3, is projected onto the front surface of the transmissive screen 2 from the back surface.

(Configuration of Optical Device Main Body)

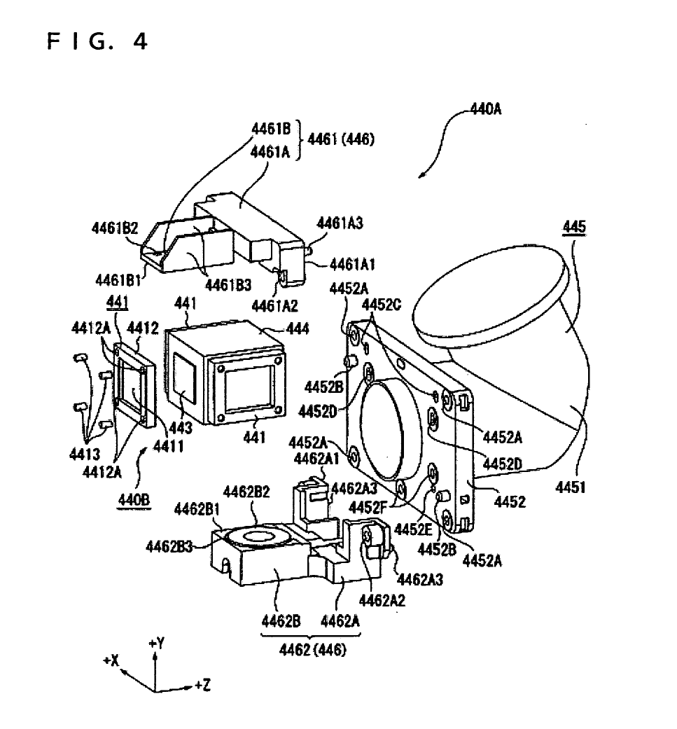

FIG. 3 and FIG. 4 are views showing the configuration of the optical device main body 440A. Referring to FIG. 3 and FIG. 4, the optical axis of lights coming out from the electro-optic device 440B and heading toward the projection lens 445 is referred to as the Z-axis, and two axes orthogonal to the Z-axis are referred to as the X-axis and the Y-axis.

The optical device main body 440A includes the electro-optic device 440B including the three light modulation devices 441, the three light exiting-side polarizers 443, and the cross dichroic prism 444, which are combined into one unit, the projection lens 445, and a supporting structure 446 that combines the electro-optic device 440B and the projection lens 445 into one unit.

(Configuration of Electro-Optic Device)

The electro-optic device 440B includes the three light modulation devices 441, the three light exiting-side polarizers 443, and the cross dichroic prism 444, which are combined into one unit in the manner as follows.

As is shown in FIG. 4, the three light exiting-side polarizers 443 are affixed to the light incident-side end faces of the cross dichroic prism 444 using a bonding agent or the like. Only the light exiting-side polarizer 443 on the side opposing the projection lens 445 is shown in FIG. 4. However, the other light exiting-side polarizers 443 are also affixed to the corresponding light incident-side end faces of the cross dichroic prism 444.

As is shown in FIG. 3 or FIG. 4, each of the three light modulation devices 441 is configured in such a manner that the liquid crystal panel 4411 is accommodated in a holding frame 4412. Each of the three light modulation device 441 is bonded and fixed to the corresponding light incident-side end face of the cross dichroic prism 444 with pins 4413 that are inserted together with a UV-curing bonding agent into holes 4412A made in the respective four corners of the holding frame 4412.

In the manner described above, the three light modulation devices 441, the three light exiting-side polarizers 443, and the cross dichroic prism 444 are combined into one unit.

(Configuration of Projection Lens)

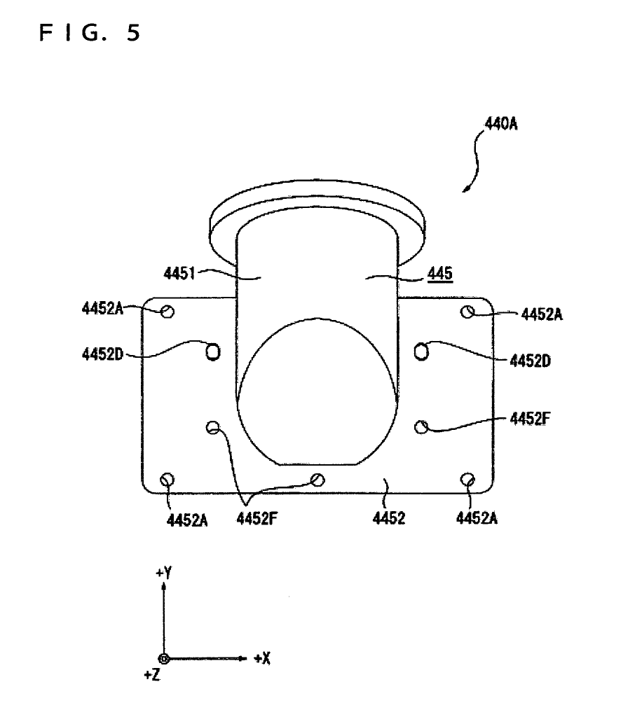

FIG. 5 is a view of the optical device main body 440A when viewed in the +Z-axis direction of FIG. 3 and FIG. 4.

The projection lens 445 includes a lens barrel 4451 (FIG. 3 through FIG. 5) that accommodates plural lenses and a mirror that deflects incident lights.

As are shown in FIG. 3 through FIG. 5, the lens barrel 4451 is of a shape such that extends in the horizontal direction (the Z-axis direction shown in FIG. 3 through FIG. 5) with the tip end being bent upward (on the side of the Y-axis direction shown in FIG. 3 through FIG. 5), and has a flange portion 4452 on the base end side. In this exemplary embodiment, the lens barrel 4451 and the flange portion 4452 are formed as one piece through mold processing. The lens barrel 4451 and the flange portion 4452 are not necessarily formed as one piece, and they may be combined into one unit after they are formed separately.

As are shown in FIG. 3 through FIG. 5, the flange portion 4452 includes a plate body of almost a rectangular shape when viewed in plane that expands from the outer peripheral portion on the base end side of the lens barrel 4451 along the X-Y plane, and it is a member connected to the supporting structure 446 and also used to fix the integrated, optical device main body 440A to the housing 45 for optical components.

As are shown in FIG. 3 through FIG. 5, at respective four corners, the flange portion 4452 is provided with fixing holes 4452A used to connect the flange portion 4452 to the housing 45 for optical components.

Also, as is shown in FIG. 3 or FIG. 4, the light incident-side end face of the flange portion 4452 is provided with positioning protrusions 4452B that fit in unillustrated positioning holes in the housing 45 for optical components, in close proximity to two diagonally opposite fixing holes 4452A out of the four fixing holes 4452A.

Further, as is shown in FIG. 4, the light incident-side end face of the flange portion 4452 is provided with two positioning holes 4452C used to position a first seat of the supporting structure 446 described below, at positions in close proximity to the upper (on the side of the +Y-axis direction in FIG. 4) corner portions. The positioning holes 4452C are concave portions formed to extend in the top-to-bottom direction (the Y-axis direction in FIG. 4), and regulate the position of the first seat in a direction (the X-axis direction in FIG. 4) orthogonal to the top-to-bottom direction.

As is shown in FIG. 4 or FIG. 5, two fixing holes 4452D are formed as track holes used to fix the first seat, at positions in close proximity to the two positioning holes 4452C. As with the positioning holes 4452C, the fixing holes 4452D are formed to extend in the top-to-bottom direction (the Y-axis direction in FIG. 4 and FIG. 5), and is formed to enable the position adjustment of the first seat in the top-to-bottom direction.

Further, as is shown in FIG. 4, the light incident-side end face of the flange portion 4452 is provided with two positioning holes 4452E used to position a second seat of the supporting structure 446 described below, at positions in close proximity to the lower (on the side of the −Y-axis direction in FIG. 4) corner portions. The positioning hole 4452E in the −X-axis direction alone is shown in FIG. 4. These positioning holes 4452E are concave portions in which positioning protrusions on the second seat described below are allowed to fit.

Furthermore, as is shown in FIG. 4 or FIG. 5, three fixing holes 4452F used to fix the second seat are provided at positions in close proximity to the two positioning holes 4452E and on the lower end (on the side of the −Y-axis direction in FIG. 4 and FIG. 5) of the lens barrel 4451.

(Configuration of Supporting Structure)

The supporting structure 446 is a member that combines the electro-optic device 440B and the projection lens 445 into one unit. As is shown in FIG. 3 or FIG. 4, the support structure includes a first seat 4461 and a second seat 4462. In this exemplary embodiment, the first seat 4461 and the second seat 4462 are formed through mold processing.

As is shown in FIG. 3 or FIG. 4, the first seat 4461 is fixed to the top surface (the end face in the +Y-axis direction in FIG. 3 and FIG. 4), which is an end face intersecting with the three light incident-side end faces of the cross dichroic prism 444 that forms the electro-optic device 440B. As is shown in FIG. 3 or FIG. 4, the first seat 4461 includes a flange connection portion 4461A extending along the flange portion 4452 of the projection lens 445, and a prism connection portion 4461B extending in a direction almost orthogonal to the flange connection portion 4461A, which are formed as one piece. The first seat 4461 is shaped like a capital T when viewed in the Y-axis direction.

As is shown in FIG. 4, the prism connection portion 4461B is a portion that is connected to the top surface of the cross dichroic prism 444, and is formed in the shape of a plate having a first supporting surface 4461B1 that extends along the top surface of the cross dichroic prism 444 and is bonded and fixed to the top surface.

As is shown in FIG. 3 or FIG. 4, the prism connection portion 4461B is provided with plural holes 4461B2 that penetrate through the first supporting surface 4461B1 and form concave portions used as bonding agent reservoirs.

A pair of reinforcing members 4461B3 that protrude upward (in the +Y-axis direction in FIG. 3 and FIG. 4) and reinforce the connection state of the flange connection portion 4461A are provided on opposing edges (both edges in the X-axis direction in FIG. 3 and FIG. 4) of the prism connection portion 4461B.

As is shown in FIG. 3 or FIG. 4, the flange connection portion 4461A is a portion that is connected to the light incident-side end face of the flange portion 4452 of the projection lens 445, and has a second supporting surface 4461A1 extending in the horizontal direction (in the X-axis direction in FIG. 3 and FIG. 4), almost orthogonal to the first supporting surface 4461B1 and connected to the light incident-side end face of the flange portion 4452.

As is shown in FIG. 3 or FIG. 4, in both end portions of the flange connection portion 4461A, in the horizontal direction (in the X-axis direction in FIG. 3 and FIG. 4), fixing holes 4461A2 used to connect the first seat 4461 to the flange portion 4452 are formed to correspond to the two fixing holes 4452D in the flange portion 4452.

In addition, as is shown in FIG. 4, the second supporting surface 4461A1 of the flange connection portion 4461A is provided with two positioning protrusions 4461A3 protruding in the out-plane direction of the second supporting surface 4461A1 to correspond to the two positioning holes 4452C in the flange portion 4452, at positions in close proximity to the two fixing holes 4461A2. The positioning protrusion 4461A3 in the X-axis direction alone is shown in FIG. 4.

In short, this exemplary embodiment adopts the configuration in which the first seat 4461 is connected to the flange portion 4452 in the Z-axis direction.

As is shown in FIG. 3 or FIG. 4, the second seat 4462 is fixed to the bottom surface (the end face in the Y-axis direction in FIG. 3 and FIG. 4), which is an end face intersecting with the three light incident-side end faces of the cross dichroic prism 444 that forms the electro-optic device 440B. In other words, the first seat 4461 and the second seat 4462 are disposed to pinch the top surface and the bottom surface of the cross dichroic prism 444, which oppose each other and intersect with the three light incident-side end faces. Similar to the first seat 4461, the second seat 4462 includes, as is shown in FIG. 3 or FIG. 4, a flange connection portion 4462A extending along the flange portion 4452 of the projection lens 445, and a prism connection portion 4462B extending in a direction almost orthogonal to the flange connection portion 4462A, which are formed as one piece. The second seat 4462 is shaped like a capital T when viewed in the Y-axis direction.

As is shown in FIG. 4, the prism connection portion 4462B is a portion connected to the bottom surface of the cross dichroic prism 444, and is formed almost in the shape of a rectangular parallelepiped having a first supporting surface 4462B1 that extends along the bottom surface of the cross dichroic prism 444 and is bonded and fixed to the bottom surface.

As is shown in FIG. 4, the first supporting surface 4462B11 is provided with a bulged portion 4462B2 that bulges out in an out-plane direction of the first supporting surface 4462B13, almost at the center portion, when viewed in the plane.

Also, as is shown in FIG. 4, a concave portion 4462B3, used as a bonding agent reservoir, is formed in the peripheral portion of the bulged portion 4462B2.

As is shown in FIG. 3 or FIG. 4, the flange connection portion 4462A is a portion connected to the light incident-side end face of the flange portion 4452 of the projection lens 445, and has a second supporting surface 4462A1 that extends in the horizontal direction (the X-axis direction in FIG. 3 and FIG. 4) to be almost orthogonal to the first supporting surface 4462B13, and is connected to the light incident-side end face of the flange portion 4452. The flange connection portion 4462A is formed in the shape of a capital U when viewed in a plane so as to surround the lower end (on the side of the Y-axis direction in FIG. 4), of the lens barrel 4451, when connected to the flange portion 4452.

As is shown in FIG. 3 or FIG. 4, fixing holes 4462A2 used to connect the second seat 4462 to the flange portion 4452 are formed in the tip ends of the U-shaped portion of the flange connection portion 4462A and in the base end of the U-shaped portion almost at the center portion in the horizontal direction (the X-axis direction in FIG. 4) to correspond to three fixing holes 4452F in the flange portion 4452. The fixing holes 4452F in the X-axis direction in the tip ends of the U-shaped portion of the flange connection portion 4462A alone are shown in FIG. 3 or FIG. 4.

Also, as is shown in FIG. 4, the second supporting surface 4462A1, of the flange connection portion 4462A, is provided with two positioning protrusions 4462A3 protruding in an out-plane direction of the second supporting surface 4462A1 to correspond to the two positioning holes 4452E in the flange portion 4452, at positions in close proximity to the two fixing holes 4462A2.

In short, this exemplary embodiment adopts the configuration in which the second seat 4462 is connected to the flange portion 4452 in the Z-axis direction as with the first seat 4461.

(Assembling Method of Optical Device Main Body)

An assembling method of the optical device main body 440A will now be described.

Initially, the cross dichroic prism 444 is fixed to the second seat 4462, after the position of the former, with respect to the latter, is adjusted.

To be more concrete, the position of the cross dichroic prism 444 is adjusted first using an unillustrated positioning jig. For this position adjustment, for example, the configuration to perform position adjustment in a manner as follows can be adopted. That is, the top surface of the cross dichroic prism 444 is detected using an optical image detection device, such as a CCD (Charge Coupled Device), and the position is adjusted by bringing the positions of crosses formed on the two dielectric multi-layer filters in the cross dichroic prism 444 to their specific positions on the basis of the detected image. Alternatively, the configuration as follows may be adopted. That is, for example, lights are guided from the light incident-side end faces of the cross dichroic prism 444, and the position of the cross dichroic prism 444 is adjusted on the basis of lights coming out from the light exiting-side end face.

After the position of the cross dichroic prism 444 is adjusted, a bonding agent is applied to the bulged portion 4462B2 of the second seat 4462 that has been set at the specific position, and the positioning jig is moved while maintaining the posture of the cross dichroic prism 444 until the bottom surface of the cross dichroic prism 444 abuts on the bulged portion 4462B2 of the second seat 4462, so that they are bonded and fixed to each other.

Various kinds of bonding agents are available as the bonding agent used herein. For example, an anaerobic bonding agent, a UV-curing bonding agent, a heat-curing bonding agent, or the like, can be adopted.

A method of fixing the cross dichroic prism 444, to the second seat 4462 after the position adjustment, is not limited to the method described above, and a method as follows may be adopted instead.

For example, the second seat 4462 is set at a specific position. Then, a heat-curing bonding agent or a UV-curing bonding agent is applied to the bulged portion 4462B2 of the second seat 4462, and the bottom surface of the cross dichroic prism 444 is caused to abut on the bulged portion 4462B2 of the second seat 4462. While the bonding agent remains in a non-cured state, the position of the cross dichroic prism 444, with respect to the second seat 4462, is adjusted in the manner as described above. After the position is adjusted, the bonding agent is cured with a hot air or UV rays in fixing the second seat 4462 and the cross dichroic prism 444.

Subsequently, the second seat 4462, to which the cross dichroic prism 444 is fixed, is connected to the flange portion 4452 of the projection lens 445.

To be more concrete, the two positioning protrusions 4462A3, on the second seat 4462, are fit in the two positioning holes 4452E in the flange portion 4452. Under this state, the second seat 4462 is positioned with respect to the flange portion 4452. That is, the cross dichroic prism 444 is positioned with respect to the projection lens 445.

The second seat 4462 is then fixed to the flange portion 4452 by threading three fixing screws (not shown) into the three fixing holes 4452F, in the flange portion 4452, via the three fixing holes 4462A, in the second seat 4462.

Subsequently, the first seat 4461 is connected to the flange portion 4452 of the projection lens 445.

To be more concrete, a bonding agent is applied to the first supporting surface 4461B1 of the first seat 4461. Like the bonding agent used when fixing the second seat 4462 and the cross dichroic prism 444, an anaerobic bonding agent, a UV-curing bonding agent, a heat-curing bonding agent, or the like, are available as the bonding agent used herein.

Also, the two positioning protrusions 4461A3 on the first seat 4461 are inserted through the two positioning holes 4452C in the flange portion 4452. The position of the first seat 4461 with respect to the flange portion 4452 in the horizontal direction (in the X-axis direction in FIG. 3 through FIG. 5) is regulated in this state.

Further, fixing screws (not shown) are inserted through the two fixing holes 4461A2 in the first seat 4461 and the two fixing holes 4452D in the flange portion 4452, and nuts (not shown) are threaded into the tip ends of the fixing screws. In this case, the fixing screws are left loose with respect to the nuts.

As has been described, because the two positioning holes 4452C and the two fixing holes 4452D in the flange portion 4452 are formed to extend in the top-to-bottom direction (in the Y-axis direction in FIG. 4), the first seat 4461 is allowed to move in the top-to-bottom direction in the state described above. The first seat 4461 is thus moved downward (in the Y-axis direction in FIG. 3 through FIG. 5) in this state until the first supporting surface 4461B1 of the first seat 4461 abuts on the top surface of the cross dichroic prism 444, so that they are bonded and fixed to each other.

Thereafter, the first seat 4461 is fixed to the flange portion 4452 by tightening the fixing screws and the nuts.

The optical device main body 440A is assembled by combining the first seat 4461, the second seat 4462, the cross dichroic prism 444, and the projection lens 445 into one unit, and then attaching the three light exiting-side polarizers 443 and the three light modulation devices 441, respectively, to the three light incident-side end faces of the cross dichroic prism 444 while adjusting their respective positions in the manner described above.

Alternatively, the three light exiting-side polarizers 443 may be laminated to the respective light incident-side end faces of the cross dichroic prism 444 while adjusting their respective positions before the second seat 4462 and the cross dichroic prism 444 are fixed to each other, or before the second seat 4462 is connected to the flange portion 4452 of the projection lens 445.

Likewise, the three light modulation devices 441 may be laminated to the respective light incident-side end faces of the cross dichroic prism 444 while adjusting their respective positions before the second seat 4462 is connected to the flange portion 4452 of the projection lens 445.

Subsequently, the positioning protrusions 4452B on the flange portion 4452 are fit in positioning holes (not shown) in the housing 45 for optical components, and four screws 453 (only two screws 453 are shown in FIG. 2) are inserted through the fixing holes 4452A in the flange portion 4452 to be threaded into the screw holes 452B in the housing 45 for optical components. The optical device main body 440A is thus fixed to the housing 45 for optical components.

In the first exemplary embodiment described above, because the first seat 4461 and the second seat 4462 are formed as separated bodies, it is possible to adopt the method like the assembling method of the optical device main body 440A as described above, by which the first seat 4461 and the second seat 4462 are fixed, respectively, to the top surface and the bottom surface of the cross dichroic prism 444 after the posture and the state of the cross dichroic prism 444 are adjusted. That is, it is possible to change relative positions of the first seat 4461 and the second seat 4462 as needed. Hence, in comparison with the configuration in the related art in which a pair of attachment portions needs to be formed at a high degree of accuracy in response to a dimensional tolerance of the cross dichroic prism 444, such high accuracy is not needed for the first seat 4461 and the second seat 4462. In addition, the configuration is compatible to various kinds of cross dichroic prism 444 having dimensions that vary from type to type of the rear projector 1. This, unlike the related art, eliminates the need to manufacture various kinds of prism holder for various kinds of cross dichroic prism 444 having different dimensions. The cost of manufacturing the first seat 4461 and the second seat 4462 can be thereby reduced, which can in turn reduce the cost of manufacturing the rear projector 1.

Also, because the opposing top and bottom surfaces of the cross dichroic prism 444 are fixedly pinched by the first seat 4461 and the second seat 4462, a force applied to the electro-optic device 440B from the outside can be suppressed by way of the first seat 4461, the second seat 4462, and the flange portion 4452. Mutual misalignment of the three light modulation devices 441 attached to the three light incident-side end faces of the cross dichroic prism 444 can thereby be reduced or suppressed. It is thus possible to project a satisfactory optical image having no pixel displacements in an enlarged form.

Because the second seat 4462 is provided with the three fixing holes 4462A2, three points including the tip ends of the U-shaped portion of the flange connection portion 4462A and almost the center portion of the base end of the U-shaped portion in the horizontal direction are fixed to the flange portion 4452 with screws. This configuration makes it possible to maintain the connected state between the electro-optic device 440B and the projection lens 445 by way of the second seat 4462 in a satisfactory manner, and a force applied to the electro-optic device 440B from the outside can be further suppressed.

In particular, the rear projector 1 may adopt the configuration in which the output values of the built-in speakers are high in comparison with a front projector that projects an optical image from a direction in which the user views the screen. In this exemplary embodiment, however, by adopting the structure, in which the electro-optic device 440B including the first seat 4461, the second seat 4462, and the flange portion 4452, and the projection lens 445 combined into one unit, to the rear projector 1, transmission of vibrations caused by outputs from the speakers to the electro-optic device 440B, in particular, can be effectively suppressed. It is thus possible to project a sharp optical image having no pixel displacements onto the transmissive screen 2.

Further, the first seat 4461 and the second seat 4462 have, respectively, the first supporting surfaces 4416B1 and 4462B1 and the second supporting surfaces 4461A1 and 4462A1, which are almost orthogonal to each other, and both second supporting surfaces 4461A1 and 4462A1 are connected to the light incident-side end face of the flange portion 4452. More specifically, the connected directions of the first seat 4461 and the second seat 4462 to the flange portion 4452 are set in the optical axis direction (Z-axis) of lights that come out from the cross dichroic prism 444 and head toward the projection lens 445. Hence, different from the configuration in the related art in which guiding grooves are formed in the lens holder at a high degree of accuracy, by merely forming both the second supporting surfaces 4461A1 and 4462A1 and the light incident-side end face of the flange portion 4452 with satisfactory accuracy, it is possible to position the first seat 4461 and the second seat 4462 with respect to the flange portion 4452 at a high degree of accuracy. That is, it is possible to position the electro-optic device 440B and the projection lens 445 at a high degree of accuracy. Hence, not only can the cost of manufacturing the first seat 4461 and the second seat 4462 be reduced, but also the cost of manufacturing of the flange portion 4452 can be reduced, which can in turn further reduce the cost of manufacturing the rear projector 1.

It should be noted that the second seat 4462 is provided with the two positioning protrusions 4462A3, whereas the flange portion 4452 is provided with the two positioning holes 4452E. The optical axis direction (Z-axis) of the electro-optic device 440B, with respect to the projection lens 445, is thus determined using the second supporting surface 4462A1 and the light incident-side end face of the flange portion 4452. A position of the electro-optic device 440B with respect to the projection lens 445 within the plane (X-Y plane) orthogonal to the optical axis (Z-axis) can be determined using the positioning protrusions 4462A3 and the positioning holes 4452E. The electro-optic device 440B can be therefore positioned with respect to the projection lens 445 using a simple configuration, which can in turn reduce the cost of manufacturing the rear projector 1.

In addition, because the first seat 4461, the second seat 4462, and the flange portion 4452 are formed through mold processing, it is easy to mold the respective connection surfaces of both of the second supporting surfaces 4461A1 and 4462A1, and the light incident-side end face of the flange portion 4452 at a high degree of accuracy in comparison with the case in the related art where the respective connection surfaces, connected in the top-to-bottom direction (Y-axis) that is orthogonal to the optical axis direction (Z-axis), are formed at satisfactory accuracy. The cost of manufacturing of the first seat 4461, the second seat 4462, and the flange portion 4452 can be thus reduced further, which can in turn further reduce the cost of manufacturing of the rear projector 1.

Moreover, because the fixing holes 4452D used to fix the first seat 4461 to the flange portion 4452 are formed to extend in the top-to-bottom direction (Y-axis), it is possible to move the first seat 4461, with respect to the flange portion 4452, in the top-to-bottom direction, while the first seat 4461 is attached to the flange portion 4452 with screws. This allows the first seat 4461 to move until the first supporting surface 4461B1 of the first seat 4461 abuts on the top surface of the cross dichroic prism 444 while the first seat 4461 is attached to the flange portion 4452 with screws, so that they are bonded and fixed to each other, after which the first seat 4461 can be fixed to the flange portion 4452 by tightening the screws. It is thus possible to perform the work to combine the electro-optic device 440B and the projection lens 445 into one unit promptly with ease using a simple configuration.

Because the second seat 4462 is provided with the bulged portion 4462B2 on the first supporting surface 4462B1, a clearance defined by the shape of the curved surface of the bulged portion 4462B2 and the bottom surface of the cross dichroic prism 444 can be filled with the bonding agent. Hence, when the bottom surface of the cross dichroic prism 444 abuts on the first supporting surface 4462B1 while the bonding agent is applied to the first supporting surface 4462B1, the bonding agent flows in a direction toward the clearance, which enables the cross dichroic prism 444 to be fixed in a reliable manner. The rear projector 1 can be therefore manufactured in a satisfactory manner.

Further, because the first supporting surface 4461B1 of the first seat 4461 is provided with the plural holes 4461B2, while the first supporting surface 4462B1 of the second seat 4462 is provided with the concave portions 4462B3, the interiors of the plural holes 4461B2 and the interiors of the concave portions 4462B3 can be filled with the bonding agent. Hence, when the top and bottom surfaces of the cross dichroic prism 444 abut, respectively, on the first supporting surfaces 4461B1 and 4462B1 while the bonding agent is applied to the both first supporting surfaces 4461B1 and 4462B1, the bonding agent flows in a direction toward the interiors of the plural holes 4461B2 and the interiors of the concave portions 4462B3. This prevents the bonding agent from flowing out on the three light incident-side end faces and the light exiting-side end face of the cross dichroic prism 444. It is thus possible to prevent the bonding agent from adhering to unwanted portions. The rear projector 1 can be therefore manufactured in a satisfactory manner.

<Second Exemplary Embodiment>

A second exemplary embodiment of the invention will now be described with reference to the drawing.

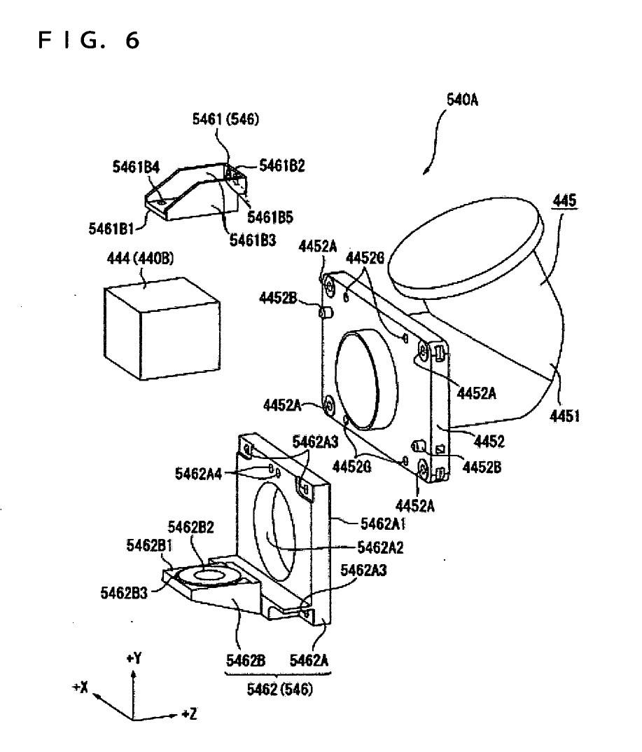

FIG. 6 is an exploded perspective view showing the structure of an optical device main body 540A in the second exemplary embodiment. The three light exiting-side polarizers 443 and the three light modulation devices 441 are omitted from FIG. 6 for ease of illustration. Referring to FIG. 6, as in FIG. 3 through FIG. 5, the optical axis of lights coming out from the electro-optic device 440B and heading toward the projection lens 445 is referred to as the Z-axis, and two axes orthogonal to the Z-axis are referred to as the X-axis and the Y-axis.

In this exemplary embodiment, as is shown in FIG. 6, only the structure of a supporting structure 546 (a first seat 5461 and a second seat 5462) in the optical device main body 540A is different from the structure of the supporting structure 446 (the first seat 4461 and the second seat 4462) described in the first exemplary embodiment above, and the other configurations of the optical device main body 540A and the configuration of the rear projector 1 are the same as those of the counterparts in the first exemplary embodiment.

As is shown in FIG. 6, the first seat 5461 forming the supporting structure 546 is of substantially the same shape as the prism connection portion 4461B described in the first exemplary embodiment. As is shown in FIG. 6, the first seat 5461 is shaped like a capital L when viewed from the side and includes a first supporting surface 5461B1 extending along the top surface of the cross dichroic prism 444 and bonded and fixed to the top surface, and a second supporting surface 5461B2 extending in a direction almost orthogonal to the first supporting surface 5461B1 and connected to the light incident-side end face of the flange portion 4452 via the second seat 5462. Also, a pair of reinforcing portions 5461B3 that extend upward (in the +Y-axis direction in FIG. 6) and reinforce the connection state between the second seat 5462 and the cross dichroic prism 444 is formed on the both edges of the first seat 5461 in the horizontal direction (the both edges in the X-axis direction in FIG. 6).

As is shown in FIG. 6, as with the first seat 4461 described in the first exemplary embodiment, the first seat 5461 is provided with plural holes 5461B4 that penetrate through the first supporting surface 5461B1 and form concave portions used as the bonding agent reservoirs.

Further, as is shown in FIG. 6, the first seat 5461 is provided with two fixing holes 5461B5 as track holes to penetrate though the second supporting surface 5461B2. These fixing holes 5461B5 are formed to extend in the top-to-bottom direction (in the Y-axis direction in FIG. 6), so that the position of the first seat 5461 with respect to the second seat 5462 can be adjusted in the top-to-bottom direction.

As is shown in FIG. 6, the second seat 5462 forming the supporting structure 546 is shaped like a capital L when viewed from the side, and includes a flange connection portion 5462A forming the horizontal portion in the shape of the capital L, and a prism connection portion 5462B forming the perpendicular portion in the shape of the capital L.

As is shown in FIG. 6, the prism connection portion 5462B is shaped substantially similar to a rectangular prism having a first supporting surface 5462B1 extending along the bottom surface of the cross dichroic prism 444 and bonded and fixed to the bottom surface.

As is shown in FIG. 6, as with the second seat 4462 described in the first exemplary embodiment, the first supporting surface 5462B1 is provided with a bulged portion 5462B2 that bulges out in an out-plane direction of the first supporting surface 5462B1 and a concave portion 5462B3 formed in the peripheral portion of the bulged portion 5462B2 to be used as a bonding agent reservoir.

As is shown in FIG. 6, the flange connection portion 5462A includes a plate body of a rectangular shape when viewed in a plane that extends along the X-Y plane. The flange connection portion 5462A is a portion that is connected to the light incident-side end face of the flange portion 4452 and supports the first seat 5461, and the light exiting-side end face forms a second supporting surface 5462A1 that is almost orthogonal to the first supporting surface 5462B1 and is connected to the light incident-side end face of the flange portion 4452.

As is shown in FIG. 6, the flange connection portion 5462A is provided with a circular hole 5462A2 almost at the center portion when viewed in a plane, through which the base end portion of the lens barrel 4451 forming the projection lens 445 can be inserted.

Also, as is shown in FIG. 6, at the four corners, the flange connection portion 5462A is provided with fixing holes 5462A3 used to fix the flange connection portion 5462A to the light incident-side end face of the flange portion 4452.

Further, as is shown in FIG. 6, the flange connection portion 5462A is provided with two fixing holes 5462A4 almost at the center portion in the horizontal direction (in the X-axis in FIG. 6) on the upper side (on the side of the +Y-axis direction in FIG. 6) to correspond to the two fixing holes 5461B5 in the first seat 5461.

As is shown in FIG. 6, the flange portion 4452 in this exemplary embodiment includes four screw holes 4452G corresponding to the four fixing holes 5462A4 in the flange connection portion 5462A forming the second seat 5462 in addition to four fixing holes 4452A and two positioning protrusions 4452B. In short, the positioning holes 4452C, 4452E, and the fixing holes 4452D and 4452F described in the first exemplary embodiment are omitted herein.

An assembling method of the optical device main body 540A will now be described. Because the assembling method of the optical device main body 540A is substantially the same as the assembling method of the optical device main body 440A described in the first exemplary embodiment, only a brief description of the optical device main body assembly method follows.

Initially, the second seat 5462 is fixed to the cross dichroic prism 444 in substantially the same manner as described in the first exemplary embodiment to fix the second seat 4462 to the cross dichroic prism 444.

Subsequently, the base end portion of the lens barrel 4451 forming the projection lens 445 is inserted through the circular hole 5462A2 in the flange connection portion 5462A. The second seat 5462 is positioned and fixed with respect to the projection lens 445, that is, the cross dichroic prism 444 is positioned and fixed with respect to the projection lens 445, by threading four fixing screws (not shown) into the four screw holes 4452G (FIG. 6) provided in the flange portion 4452 via the four fixing holes 5462A3.

As has been described above, after the second seat 5462, the cross dichroic prism 444, and the projection lens 445 are combined into one unit, the first seat 5461 is connected to the flange connection portion 5462B of the second seat 5462.

More concretely, the bonding agent is applied to the first supporting surface 5461B1 of the first seat 5461. As with the bonding agent described in the first exemplary embodiment, an anaerobic bonding agent, a UV-curing bonding agent, a heat-curing bonding agent, and the like are available as the bonding agent used herein. Also, two fixing screws (not shown) are inserted through the two fixing holes 5461B5 in the first seat 5461, and the fixing screws are threaded into the two fixing holes 5462A4 in the second seat 5462. In this instance, the fixing screws are left loose.

As has been described above, because the two fixing holes 5461B5 in the first seat 5461 are formed to extend in the top-to-bottom direction (in the Y-axis direction in FIG. 6), the first seat 5461 is allowed to move in the top-to-bottom direction in the state described above. Under this state, the first seat 5461 is moved downward (in the −Y-axis direction in FIG. 6) until the first supporting surface 5461B1 of the first seat 5461 abuts on the top surface of the cross dichroic prism 444, so that they are bonded and fixed to each other.

Thereafter, the first seat 5461 is fixed to the second seat 5462 by tightening the fixing screws in the fixing holes 5462A4.

The optical device main body 540A is assembled by combining the first seat 5461, the second seat 5462, the cross dichroic prism 444, and the projection lens 445 into one unit in the manner described as above, and by attaching the three light exiting-side polarizers 443 and the three light modulation devices 441 in the same manner as in the first exemplary embodiment.

The second exemplary embodiment is different from the first exemplary embodiment in that the flange connection portion 5462A of the second seat 5462 includes a plate body of a rectangular shape when viewed in a plane that extends along the flange portion 4452, and it is connected to the light incident-side end face of the flange portion 4452 and supports the first seat 5461. Hence, it is possible to enlarge the second supporting surface 5462A1 of the second seat 5462 and to secure more connected points (four fixing holes 5462A3) in comparison with the first exemplary embodiment. The second seat 5462 is thus able to maintain the supporting state of the electro-optic device 440B with respect to the projection lens 445 in a satisfactory manner. Also, the second seat 5462 together with the first seat 5461 is able to further suppress a force applied to the electro-optic device 440B from the outside. Mutual misalignment of the three light modulation devices 441 attached to the three light incident-side end faces of the cross dichroic prism 444 can therefore be suppressed. It is thus possible to project a sharp optical image having no pixel displacements onto the transmissive screen 2.

<Third Exemplary Embodiment>

A third exemplary embodiment will now be described with reference to the drawings.

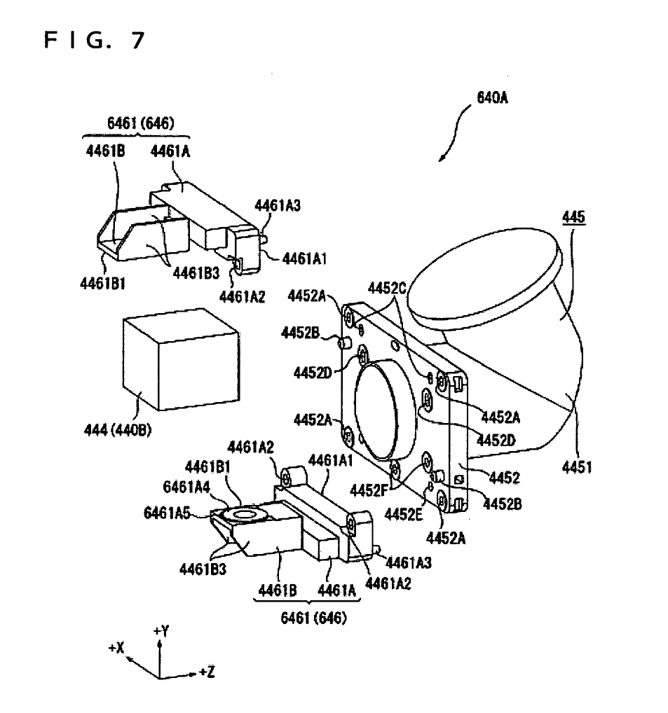

FIG. 7 is an exploded perspective view showing the structure of an optical device main body 640A in the third exemplary embodiment. The three light exiting-side polarizers 443 and the three light modulation devices 441 are omitted from FIG. 7 for ease of illustration. Referring to FIG. 7, as in the FIG. 3 through FIG. 6, the optical axis of lights emitted from the electro-optic device 440B, and heading toward the projection lens 445, is referred to as the Z-axis, and two axes orthogonal to the Z-axis are referred to as the X-axis and the Y-axis.

In this exemplary embodiment, as is shown in FIG. 7, only the structure of a supporting structure 646 (two seats 6461) of the optical device main body 640A is different from the structure of the supporting structure 446 (the first seat 4461 and the second seat 4462) described in the first exemplary embodiment above, and the other configurations of the optical device main body 640A and the configuration of the rear projector 1 are the same as those of the counterparts in the first exemplary embodiment.

As is shown in FIG. 7, the supporting structure 646 includes two seats 6461 of an identical shape, serving as a first seat and a second seat. These two seats 6461 are of substantially the same shape as the first seat 4461 described in the first exemplary embodiment. Hence, as with the first seat 4461, each seat 6461 includes a flange connection portion 4461A (including a second supporting surface 4461A1, two fixing holes 4461A2, and two positioning protrusions 4461A3), and a prism connection portion 4461B (including a first supporting surface 4461B1 and reinforcing portions 4461B3).

As is shown in FIG. 7, the first supporting surface 4461B1 of the seat 6461 is provided with a bulged portion 6461A4 that bulges out in an out-plane direction of the first supporting surface 4461B1, and a concave portion 646 1A5 in the peripheral portion of the bulged portion 6461A4 to be used as the bonding agent reservoir.

Although it is not shown concretely in the drawing, the second supporting surface 4461A1 of the seat 6461 is provided with a fixing hole, at about the center portion in the horizontal direction (the X-axis direction in FIG. 7) on the lower side (on the side of the −Y-axis direction in FIG. 7), to correspond to a fixing hole 4452F in the flange portion 4452, at about the center portion in the horizontal direction (the X-axis direction in FIG. 7) on the lower side (on the side of the −Y-axis direction in FIG. 7). Of the two seats 6461, the seat 6461 on the lower side (on the side of the −Y-axis direction in FIG. 7) is fixed to the flange portion 4452 using two fixing holes 4461A2 and three fixing holes with fixing screws.

Because an assembling method of the optical device main body 640A is substantially the same as the assembling method of the optical device main body 440A described in the first exemplary embodiment, the description of the assembling method is omitted herein.

The third exemplary embodiment is different from the first exemplary embodiment in that the two seats 6461 forming the supporting structure 646 are of identical shape. Hence, the two seats 6461 fixed to the top and bottom surfaces of the cross dichroic prism 444 can be manufactured using the same manufacturing device through the same manufacturing method by using the seats 6461 in common. This simplifies the structure to combine the electro-optic device 440B and the projection lens 445 into one unit. It is thus possible to reduce the cost of manufacturing of the first seat and the second seat, which can in turn further reduce the cost of manufacturing of the rear projector 1.

The way in which the exemplary embodiments have been herein described is not limited, and the exemplary embodiments can be modified and changed in design in various manners without deviating from the scope and spirit of the invention.

In the respective exemplary embodiments above, the shapes of the supporting structures 446, 546, and 646 are not limited to the shapes described in the respective exemplary embodiments. More specifically, they may be of any other shape as long as the first seats 4461, 5461, the second seat 4462, 5462, and the seats 6461 include the first supporting surfaces 4461B1, 4462B1, 5461B1, and 5462B1, and the second supporting surfaces 4461A1, 4462A1, 5461B2, and 5462A1 that are almost orthogonal to each other.

In the first exemplary embodiment, the fixing holes 4452D in the flange portion 4452 are formed as track holes. However, the exemplary embodiments are not limited to this configuration, and the fixing holes 4461A2 in the first seat 4461 may be formed as track holes. Likewise, in the second exemplary embodiment, the fixing holes 5461B5 in the first seat 5461 are formed as track holes; however, the exemplary embodiments are not limited to this configuration, and the fixing holes 5462A4 in the second seat 5462 may be formed as track holes.

In the first exemplary embodiment and the second exemplary embodiment, the first supporting surfaces 4462B1 and 5462B1 of the second seat 4462 and 5462 are provided with the bulged portions 4462B2 and 5462B2. However, the exemplary embodiments are not limited to this configuration, and it may be configured in such a manner that the first supporting surfaces 4461B1 and 5461B1 of the first seats 4461 and 5461 are provided with bulged portions.

In the first exemplary embodiment and the second exemplary embodiment, the first seats 4461 and 5461 are provided with plural holes 4461B2 and 5461B4 that penetrate through the first supporting surfaces 4461B1 and 5461B1 to form concave portions used as the bonding agent reservoirs. However, the exemplary embodiments are not limited to this configuration. For example, concave portions used as the bonding agent reservoirs may be formed as concave portions that recess in the thickness direction of the first supporting surfaces 4461B1 and 5461B1, or they may be formed by providing notches in the light incident-side end portions (the end portions in the Z-axis direction in FIG. 4 and FIG. 6) of the first seats 4461 and 5461.

In the first exemplary embodiment and the second exemplary embodiment, one of the first seat 4461 and the second seat 4462, and one of the first seat 5461 and the second seat 5462 may be formed integrally with the flange portion 4452.

When configured in this manner, because one of the seats is formed integrally with the flange portion 4452, one of the seats is able to maintain the supporting state of the electro-optic device 440B with respect to the projection lens 445 in a satisfactory manner. Also, the seat together with the other seat is able to further suppress a force applied to the electro-optic device 440B from the outside. It is thus possible to project a sharp optical image having no pixel displacements in an enlarged form. Also, by forming one of the seats integrally with the flange portion 4452, the number of components used to combine the projection lens 445 and the electro-optic device 440B can be lessened. The assembling work to combine the projection lens 445 and the electro-optic device 440B into one unit can be thereby performed with ease, which can in turn reduce the cost of manufacturing the rear projector 1.

The respective exemplary embodiments described only one example of the rear projector 1 that uses three light modulation devices 441. However, the exemplary embodiments are also applicable to a rear projector using two light modulation devices or a rear projector using four or more light modulation devices.

The respective exemplary embodiments described only a rear projector that projects an optical image in a direction opposite to a direction in which the user views the screen as an example of the projector. However, the exemplary embodiments are also applicable to a front projector that projects an optical image in a direction in which the user views the screen.

The best mode for carrying out the exemplary embodiments have been disclosed in the description above. It should be appreciated, however, that the exemplary embodiments are not limited to the description above. To be more specific, the exemplary embodiments have been illustrated and described chiefly by way of particular exemplary embodiments. However, anyone skilled in the art is able to modify the exemplary embodiments described above in shape, material, quantity, and any other detailed configurations without deviating from the technical idea, scope and spirit of the invention.

Descriptions limiting the shapes and materials as disclosed above are provided as mere examples to provide better understanding of the exemplary embodiments, and do not limit the invention. Descriptions of members under the names such that remove, either partially or entirely, the limitations on shapes and materials are therefore included in the exemplary embodiments.

The projector of the exemplary embodiments is useful as a rear projector used in a home theater or the like, because the electro-optic device and the projection device can be combined into one unit, and misalignment of plural light modulation devices with respect to one another can therefore be suppressed or reduced by controlling a force applied to the electro-optic device from the outside, while the cost of manufacturing can be reduced.

What is claimed is:

1. A projector, comprising:
a light source;
an electro-optic device having plural light modulation devices that modulate lights emitted from the light source according to image information, and a light combining device, provided with plural light incident-side end faces to which the plural light modulation devices are attached, that combines respective lights modulated in the plural light modulation devices to form an optical image;
a projection device that includes at least one lens and a lens barrel accommodating and holding the lens, and projects the optical image formed in the electro-optic device in an enlarged form, the lens barrel including a flange portion that expands outward in a base end portion in a projection direction; and
a first seat and a second seat formed as separate bodies and attached, respectively, to opposing two end faces of the light combining device that are orthogonal to the plural light incident-side end faces;
the electro-optic device and the projection device being combined into one unit, as the first seat and the second seat are connected to the flange portion.

2. The projector according to claim 1,
the first seat and the second seat including first supporting surfaces extending along the two end faces of the light combining device and attached, respectively, to the two end faces, and second supporting surfaces both extending to be almost orthogonal to the first supporting surfaces and connected to a light incident-side end face of the flange portion.

3. The projector according to claim 1,
further including a screw, at least one of the first seat and the second seat being fixed to the light incident-side end face of the flange portion with the screw;
one of, at least one of the first seat and the second seat, and the flange portion, being provided with a track hole, through which the screw is inserted and with which a relative position of the seat and the flange portion is changed while the screw is inserted.

4. The projector according to claim 1,
at least one of the first seat and the second seat being provided with a bulged portion that bulges out in an out-plane direction on a supporting surface that abuts the light combining device.

5. The projector according to claim 1,
at least one of the first seat and the second seat being bonded and fixed to at least one of the two end faces of the light combining device with a bonding agent, and including a concave portion, used as a bonding agent reservoir, in a supporting surface that abuts the light combining device.

6. The projector according to claim 1,
at least one of the first seat and the second seat being provided with a connection portion that extends along the light incident-side end face of the flange portion, and being connected to the light incident-side end face; and
the other one of the first seat and the second seat being connected to the light incident-side end face of the flange portion via the connection portion.

7. The projector according to claim 1,
one of the first seat and the second seat being formed integrally with the flange portion.

8. The projector according to claim 1,
the first seat and the second seat having an identical shape.

9. The projector according to claim 1, further comprising:
a box-shaped armor housing that accommodates the light source, the electro-optic device, and the projection device; and
a transmissive screen, provided to be exposed to any of box-shaped side surfaces of the armor housing, onto which the optical image projected from the projection device in an enlarged form is projected.
